(19) United States
(12) Patent Application Publication
(10) Pub. No.: US 2015/0221307 A1
(43) Pub. Date: Aug. 6, 2015

(54) TRANSITION FROM LOW POWER ALWAYS LISTENING MODE TO HIGH POWER SPEECH RECOGNITION MODE

(71) Applicants: Saurin Shah, Portland, OR (US); Bryan R. Peebler, El Dorado Hills, CA (US); Francis M. Tharappel, Portland, OR (US); Saurabh Dadu, Tigard, OR (US); Pierre-Louis Bossart, Austin, TX (US); Devon Worrell, Folsom, CA (US); Edward V. Gamsaragan, El Dorado Hills, CA (US); Ivan Le Hin, Toulouse (FR); Rakesh A. Ughreja, Bangalore (IN); Singaravelan Nallasellan, Bangalore (IN); Mandar S. Joshi, Saratoga, CA (US); Ohad Falik, Kfar Saba (IL)

(72) Inventors: Saurin Shah, Portland, OR (US); Bryan R. Peebler, El Dorado Hills, CA (US); Francis M. Tharappel, Portland, OR (US); Saurabh Dadu, Tigard, OR (US); Pierre-Louis Bossart, Austin, TX (US); Devon Worrell, Folsom, CA (US); Edward V. Gamsaragan, El Dorado Hills, CA (US); Ivan Le Hin, Toulouse (FR); Rakesh A. Ughreja, Bangalore (IN); Singaravelan Nallasellan, Bangalore (IN); Mandar S. Joshi, Saratoga, CA (US); Ohad Falik, Kfar Saba (IL)

(21) Appl. No.: 14/360,072

(22) PCT Filed: Dec. 20, 2013
(86) PCT No.: PCT/US2013/077222

§ 371 Date: May 22, 2014

(51) Int. Cl. G10L 15/28

(52) U.S. Cl. CPC G10L 15/28

(57) ABSTRACT

Disclosed are embodiments for seamless, single-step, and speech-triggered transition of a host processor and/or computing device from a low functionality mode to a high functionality mode in which full vocabulary speech recognition can be accomplished. First audio samples are captured by a low power audio processor while the host processor is in a low functionality mode. The low power audio processor may identify a predetermined audio pattern. The low power audio processor, upon identifying the predetermined audio pattern, triggers the host processor to transition to a high functionality mode. An end portion of the first audio samples that follow an end-point of the predetermined audio pattern may be stored in system memory accessible by the host processor. Second audio samples are captured and stored with the end portion of the first audio samples. Once the host processor transitions to a high functionality mode, multi-channel full vocabulary speech recognition can be performed and functions can be executed based on detected speech interaction phrases.

### TECHNICAL FIELD

Embodiments described herein generally relate to transitioning a computing device from a low power and/or low functionality state to a higher power and/or higher functionality state. More particularly, the disclosed embodiments relate to use of a low power voice trigger to seamlessly initiate a transition of a host processor from a low power and/or low functionality state to a higher power state and/or higher functionality state in which multi-channel speech recognition may be performed.

### BACKGROUND

Speech recognition is becoming common place in computing devices generally, and particularly in mobile computing devices, such as smartphones, tablets, and laptop computers. Presently, initiating speech recognition applications typically requires a user to manipulate an actuator (e.g., push a button) and wait for a prompt (e.g., an audio tone and/or a user interface displaying a microphone) that indicates the computing device is ready to listen, before the user can utter a command, such as, “What is the weather today?” In other words, currently speech recognition is a multi-step process, including an initiation step by a user followed by a pause before a prompting step by the computing device. Only after the prompting step can the user proceed to provide a command and/or otherwise interface with the speech recognition application of the computing device.

### BRIEF DESCRIPTION OF THE DRAWINGS

FIG. 1 is a schematic diagram of a computing device, according to one embodiment.

FIG. 2 is a schematic diagram of a digital signal processor, according to one embodiment.

FIG. 3 is a relational diagram of a computing device, according to one embodiment.

FIGS. 4A and 4B are a flow diagram of a method of transitioning a computing device from a low power mode to a higher power mode, according to one embodiment.

### DETAILED DESCRIPTION OF PREFERRED EMBODIMENTS

Presently, to initiate speech recognition applications on computing devices, a multi-step process is utilized. For example, first, a user is required to manipulate an actuator (e.g., push a button) or utter a trigger phrase to alert and/or awake a host processor speech recognition function and, second, the user must wait for the computing device to provide a prompt indicating that the computing device is ready to listen before the user can utter a command or otherwise interface with the speech recognition functionality of the computing device. This example process includes at least an initiation step by a user followed by a prompting step by the computing device. After the prompting step the user can proceed to provide a command and/or otherwise interface with a speech recognition function of the computing device.

The present inventors have recognized that a multi-step initiation of speech recognition is cumbersome and unnatural. User experience is affected by the time waiting for the computing device to transition to a higher functionality mode and to provide a prompt to indicate readiness to perform speech recognition. The disclosed embodiments provide a seamless, single-step, and voice-triggered transition of a host processor and/or computing device from a low functionality mode, which may be a low power mode and/or a limited feature mode, to a high functionality mode, which may be a higher power mode and/or a higher feature mode in which single-channel and/or multi-channel audio processing and full vocabulary speech recognition can be accomplished. The disclosed embodiments enable more natural speech interaction by enabling a single-step (or “one-shot”) seamless transition of a system from the low functionality mode to the high functionality mode.

In certain embodiments, the low functionality mode is a low power mode. The low power mode may include low power always listening functionality. In certain such embodiments, the low functionality mode may also be a limited feature mode in which certain features of the host processor are inactive or otherwise unavailable. In other embodiments, the low functionality mode is a limited feature mode in which certain features of the host processor are inactive or otherwise unavailable. In certain embodiments, the high functionality mode is a high (or higher) power mode and/or a higher feature mode in which more features of the host processor are active or otherwise operable than in the low functionality mode. The high functionality mode may include large vocabulary speech recognition functionality.

The disclosed embodiments may capture first audio samples by a low power audio processor while a host processor is in a low functionality mode. The low power audio processor may identify a predetermined audio pattern (e.g., a wake up phrase, such as “Hey Assistant”) in the first audio samples. The low power audio processor may, upon identifying the predetermined audio pattern, trigger the host processor to transition to a high functionality mode. An end portion of the first audio samples that follow an end-point of the predetermined audio pattern may be copied or otherwise stored in system memory accessible by the host processor. Subsequent audio samples, or second audio samples, are captured and stored with the end portion of the first audio samples in system memory. Once the host processor wakes up and transitions from the low functionality mode to a high functionality mode, the end portion of the first audio samples and the second audio samples may be processed by the host processor in the high functionality mode. The host processor in the high functionality mode can perform full vocabulary speech recognition to identify commands and perform functions based on detected commands and otherwise enables speech interaction.

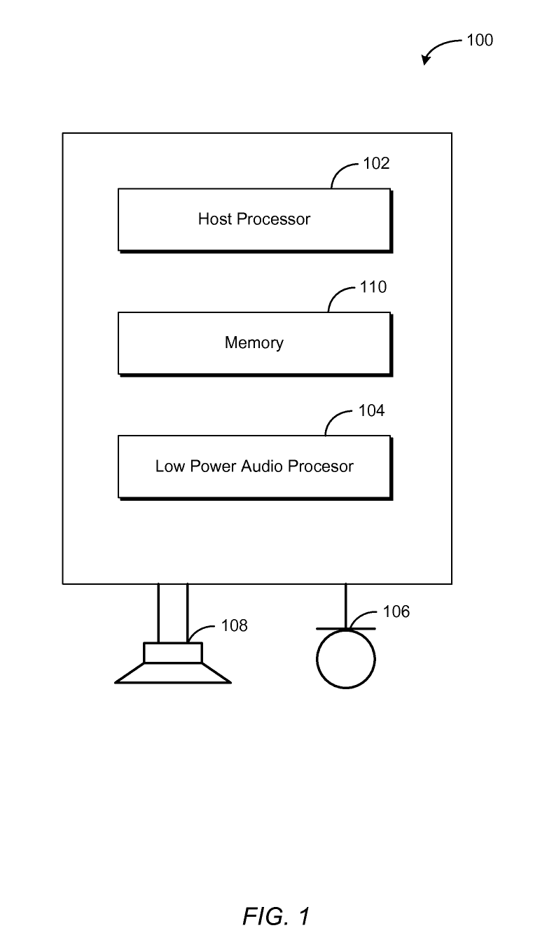

FIG. 1 is a schematic diagram of a computing device 100, according to one embodiment. The computing device 100 includes a host processor 102, a low power audio processor 104 or other dedicated hardware, one or more audio inputs 106 (e.g., microphones or microphone port), an audio output 108 (e.g., a speaker or speaker port), and a memory 110. The computing device 100 may be a mobile device, such as a smartphone, a tablet, a laptop, an Ultrabook™, a personal digital assistant, or the like. In other embodiments, the computing device 100 may also be a desktop computer, an all-in-one, or a wearable (e.g., a watch). In still another embodiment, the computing device 100 may be a dashboard unit or other processing unit of an automobile. The computing device 100 may be configured to enable a seamless or one-step activation of a voice recognition application while in a low power and/or low functionality state.

The host processor 102 may be a central processing unit (CPU) or application processor of the computing device 100, or may be any type of processor, such as a micro-processor, an embedded processor, a digital signal processor (DSP), a network processor, or other device to execute code. The host processor 102 may include one or more processing elements or cores. The host processor 102 has a low functionality mode (e.g. a low power mode or state and/or a low functionality mode or state), such as a stand-by mode, hibernate mode, or sleep mode, which may conserve power and battery life when, for example, the host processor 102 is not in use. The host processor 102 may also have one or more higher functionality modes (e.g., higher power modes or states and/or higher functionality modes or states), such as an operational mode or full-power mode, in which the host processor 102 may execute instructions to perform, for example, computing and/or data processing tasks. For example, the host processor 102 may be activated or triggered to awake (or “wake-up”) from the low functionality mode and may be able to perform large vocabulary speech recognition. As can be appreciated, the host processor 102 may be able to perform other computing tasks such as media content playback.

The low power audio processor 104 may be a second processor (or other hardware) that operates with less power than the high functionality mode(s) of the host processor 102. The low power audio processor 104 may be a digital signal processor. The lower power audio processor 104 can detect utterance of a predetermined audio pattern and trigger the host processor 102 to transition from a low functionality mode to a high functionality mode. The low power audio processor 104 may enable a single step and/or seamless transition from the low functionality mode and low power small vocabulary speech recognition, to a high functionality mode and full vocabulary speech recognition.

The low power audio processor 104 may be configured to sample an audio signal received through an audio input 106, such as via a microphone. The microphone may be an onboard microphone (e.g., onboard the computing device 100) or may be a microphone of another device, such as a headset, coupled to the computing device 100 via an audio input port 106.

The low power audio processor 104 may store audio samples from the audio signal. The audio samples may be stored in a storage device (e.g. a buffer), of the low power audio processor 104. For example, the low power audio processor 104 may include closely coupled static random-access memory (SRAM). As another example, the storage device of the low power audio processor 104 may be data closely coupled memory (DCCM). A circular buffer may be configured in the storage device and may be constantly written and overwritten with audio samples as the low power audio processor 104 samples the audio signal In other embodiments, the audio samples may be stored in the memory 110, external to the low power audio processor 104 and/or otherwise accessible to the host processor 102.

As soon as noise is detected, the low power audio processor 104 may initiate a low-power speech recognition mode to analyze or otherwise process the audio samples to identify a predetermined audio pattern. The predetermined audio pattern may be a voice trigger or preconfigured wake-up phrase. For example, the voice trigger or wake-up phrase may be “Hey Assistant.” The predetermined audio pattern may be configurable by a user. The number of predetermined audio patterns that the system may recognize may be limited, such that the low power audio processor 104 need only perform small vocabulary speech recognition and need not perform large vocabulary speech recognition. For example, the low power audio processor 104 may be able to recognize a small set of predetermined audio patterns, such as five voice triggers. Small vocabulary speech recognition to identify one of this small set of predetermined audio patterns can be accomplished with a limited amount of processing and/or power.

In addition to or as an alternative to limiting the number of predetermined audio patterns, the amount of time the predetermined audio pattern can consume may be limited, for example, to about two seconds. The limit may be imposed at an application layer to ensure that the audio samples that reach the hardware are usable to accomplish low-power speech recognition. For example, when the end user says, “Hey Assistant,” as the wake-up phrase, the duration of the first set of audio samples may be limited to two seconds.

Once the predetermined audio pattern is detected, the low power audio processor 104 may trigger the host processor 102 to wake up or transition from a low functionality mode to a high functionality mode. The low power audio processor 104 continues capturing audio samples. Additional audio inputs 106, such as additional onboard microphones, may be activated. During the period that it takes for the host processor 102 and/or the computing device 100 to wake up and transition from a low functionality mode to a high functionality mode, pre-processing may occur. The pre-processing may include acoustic echo cancellation, noise suppression, and the like to clean-up the audio samples and thereby enhance large vocabulary speech recognition. The portion of the first audio samples following an end point of the predetermined audio pattern and second audio samples may be flushed to system memory 110. For example, the end portion of the first audio samples and the second audio samples may be copied to a ring buffer in system memory 110.

The memory 110 is accessible to the host processor 102. The system memory 110, according to one embodiment, may include double data rate synchronous dynamic random access memory (DDR SDRAM).

Once the host processor 102 has transitioned to the high functionality mode, a notification may be received by the host processor that the predetermined audio pattern was detected by the low power audio processor 104. The notification may be delivered via an interrupt, an inter-process communication (IPC), doorbell registers, or any other appropriate processor to processor communication. By the time the user is finished uttering the wake up phrase and a speech interaction phrase (e.g., “Hey Assistant, what time is my next appointment?”), the speech interaction phrase can be pre-processed, the host processor 102 can transition to a higher power, and an application that does large vocabulary speech recognition is parsing the information to take action based upon the uttered speech interaction phrase. The user is able to utter the wake up phrase, “Hey Assistant” and a speech interaction phrase “what time is my next appointment?” in a seamless, natural manner, without a pause.

Following this initial speech interaction phrase (e.g., a phrase following the wake-up phrase), the user may naturally pause to await a response or an action by the computing device. During this pause, audio samples captured from the activated additional audio inputs, such as one or more onboard microphones, may begin being copied to memory 104. In other words, multi-channel audio sampling may be turned on following the initial speech interaction phrase to avoid discontinuities of the audio signal between the end portion of the first samples and the second samples. Such discontinuities between the end portion of the first samples and the second samples may inhibit large vocabulary speech recognition and may be undesirable.

The audio output 108, such as a speaker, of the computing device 100 may enable presentation of content playback to a user. The host processor may send user interaction signals to the audio output. The computing device 100 may include a low power audio playback application. Accordingly, the low power audio processor 104 may also be configured to performing acoustic echo cancellation to be able to then detect the predetermined audio pattern by low power speech recognition.

As can be appreciated, the foregoing features can be combined in a number of ways and/or may take varying forms. For example, as system memory speeds increase, audio samples captured by the low power audio processor 104 may be stored directly to a single buffer in system memory 110 accessible by the host processor 102 and the low power audio processor 104.

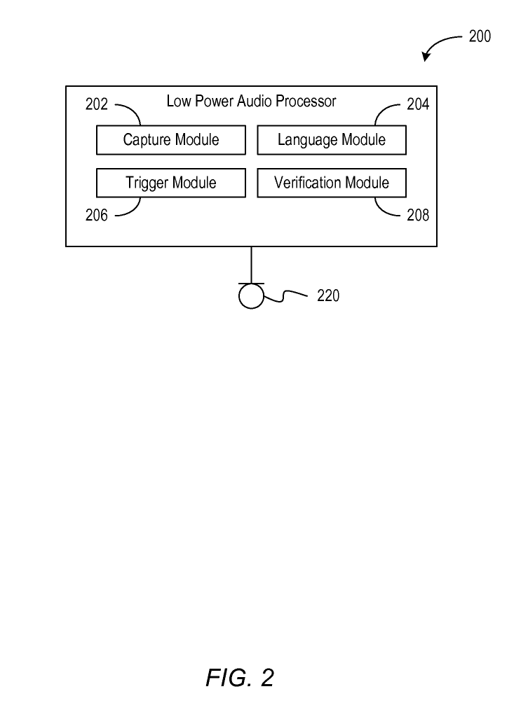

FIG. 2 is a schematic diagram of a low power audio processor 200 of a computing device according to one embodiment. The low power audio processor 200 may be similar to the low power audio processor 104 of FIG. 1. The low power audio processor 200 may be a digital signal processor. The low power audio processor 200 may function as a firmware solution that enables low power operation when a host processor (e.g., central processing unit/CPU) (e.g., host processor 102 of FIG. 1) is initially in a standby mode. The illustrated low power audio processor 200 includes a capture module 202 that monitors an input audio signal from an onboard microphone 220 of the low power audio processor 200 and/or of the computing device while the host processor is in the standby mode. A language module 204 may identify a predetermined audio pattern in samples captured from the input audio signal. A trigger module 206 may trigger the host processor to transition from a low functionality mode to a high functionality mode. The trigger module 206 may also trigger a speech recognition session or application on the host processor. A verification module 208 may operate to verify a source (e.g., user, originator) of an utterance of a wake-up phrase. The verification module 208 may therefore address a speech interaction phrase according to a given user. The verification module 208 may also ensure that only authorized individuals may trigger a speech recognition session on the computing device.

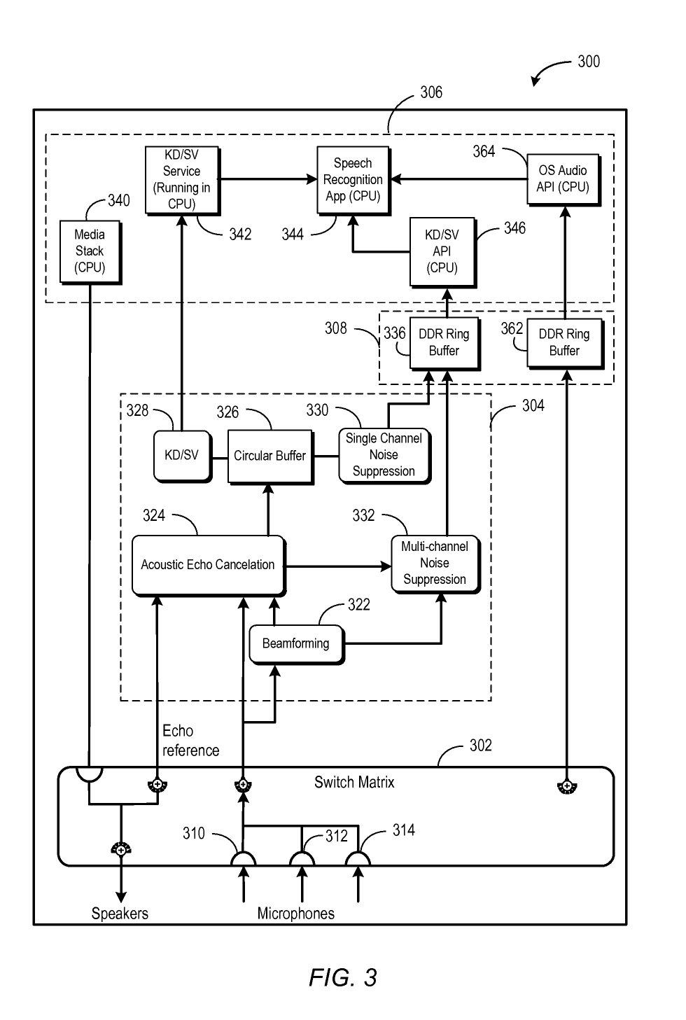

FIG. 3 is a functional diagram of a computing device 300, according to one embodiment. The computing device 300 performs various functions and may include various processors, modules, and other hardware elements to perform these functions. For example, the computing device 300 as illustrated includes a switch matrix 302, a low power audio processor 304, a host processor 306, and memory 308. The computing device 300 has a low functionality mode and a high functionality mode. More specifically, the host processor 306 of the computing device 300 has a low functionality mode and a high functionality mode. In the illustrated embodiment, the low functionality mode of the host processor 306 includes a low power mode and the high functionality mode of the host processor 306 includes a high power mode.

The switch matrix 302 receives various sources of audio input and may present audio samples to the low power audio processor 304. The audio input may be previously sampled (e.g., already digitized) or the switch matrix may provide sampling functionality. A low power microphone 310 may operate whenever the computing device 300 is operational, including when the computing device 300 is in the low functionality mode. The switch matrix 302 may provide samples of an audio signal received through the low power microphone 310. The switch matrix 302 may also receive an audio input from a media stack 340 (e.g., content playback signal) that can be used as an echo reference. The switch matrix 302 may include one or more additional microphones 312, 314 that may be deactivated while the computing device 300 is in a low functionality mode and may be activated as part of a transition of the computing device 300 from the low functionality mode to a high functionality mode.

In other embodiments, the switch matrix 302 may be a bus or an audio router. In other embodiments, a low power microphone 310 may be linked directly to the low power audio processor 304. In still other embodiments, the switch matrix 302 may be included as part of the low power audio processor 304.

Audio samples may be captured from an audio signal received by the microphone 310 while the host processor 306 and/or the computing device 308 are in the low functionality mode. Acoustic echo cancellation 324 may be applied if the media stack 340 and/or computing device 300 is in a content playback mode (e.g., an audio content playback mode). The audio samples may then be stored in a circular buffer 326. Keyword detection and/or speaker verification 328 (KD/SV) is performed on the samples stored to the circular buffer to identify a predetermined audio pattern (e.g., a wake up phrase uttered by a user). If the predetermined audio pattern is identified in first samples in the circular buffer 326, a notification may be sent to the KD/SV service 342 on the host processor 306 in a low functionality mode. The notification may be an interrupt, IPC, or the like to trigger the host processor 306 to transition to the high functionality mode and/or to initiate a speech recognition application.

At least a portion of first audio samples in the circular buffer (e.g., a portion after an endpoint of the predetermined pattern) may undergo single channel noise suppression before being copied to a ring buffer 336 in memory 308. Portions of the first audio samples before the endpoint (i.e., the predetermined audio pattern) may be stripped out and not written to the ring buffer 336 in memory. Upon detection of the predetermined audio pattern by KD/SV 328, the one or more additional microphones 312, 314 may be activated and the computing device and/or low power audio processor may begin capturing audio samples of multiple channels and multi-channel noise suppression 332 may occur. Beamforming 322 may also be performed on the multiple channels.

Until a silence period occurs following detection of the predetermined audio pattern, single microphone capture and single channel noise suppression may continue and subsequent audio samples or second audio samples may be written to the ring buffer 336 in memory 308. Alternatively, the low power audio processor 304 may continuing storing audio samples captured from the single microphone 310 to the circular buffer 326. Either way, the low power audio processor 304 continues performing single channel noise suppression 330, and writing the audio samples to the ring buffer 336 in memory 308. The multi-channel audio samples may not be written to the ring buffer 336 in memory 308 initially in order to avoid discontinuities in the audio signal while a user continues speech interface with the computing device 300. Once a silence period occurs (e.g., after utterance of a wake up phrase and a speech interaction phrase, such as “Hey Assistant, what time is my next appointment?”), audio samples captured by multiple channels and run through multi-channel noise suppression 332 may be written directly to the ring buffer 336 in memory 308. In other words, multi-microphone capture and multi-channel noise suppression may be enabled, but the result is not enabled to avoid discontinuities in the signal during a user utterance. The result of multi-microphone capture and multi-channel noise suppression may be enabled during a period of silence between utterances.

In another embodiment, the result of multi-microphone capture and multi-channel noise suppression may be activated as readily as available and a convergence process may be performed to resolve any discontinuities created by the shift from single channel to multi-channel processing.

Once in the high functionality mode, the host processor 306 may perform large vocabulary speech recognition 344 on the audio samples written to the ring buffer 336 in memory 308. A KD/SV application program interface (API) 346 may enable the speech recognition application 344 to receive or otherwise access audio samples from the ring buffer 336 in memory 308. The KD/SV API may coordinate a shift from single channel audio processing and multi-channel audio processing.

The computing device 300 may also be enabled to enter a speech recognition application using presently available methods, including multiple step processes that include a user action followed by a pause to await an indication by the computing device that the computing device is prepared to receive a command or other speech interaction phrase. Upon activation, such as by a button or by a voice trigger, the computing device 300 may provide a prompt (e.g., via display screen or via the speakers) to indicate that the computing device 300 is prepared to receive audio for speech recognition. Audio samples are written to a ring buffer 362 in memory 308 and the speech recognition application 344 may perform large vocabulary speech recognition by receiving or otherwise accessing the audio samples via the operating system audio API 364. In this manner, the computing device 300 can enable speech interfacing and/or a conversation user interface by presently available methodologies.

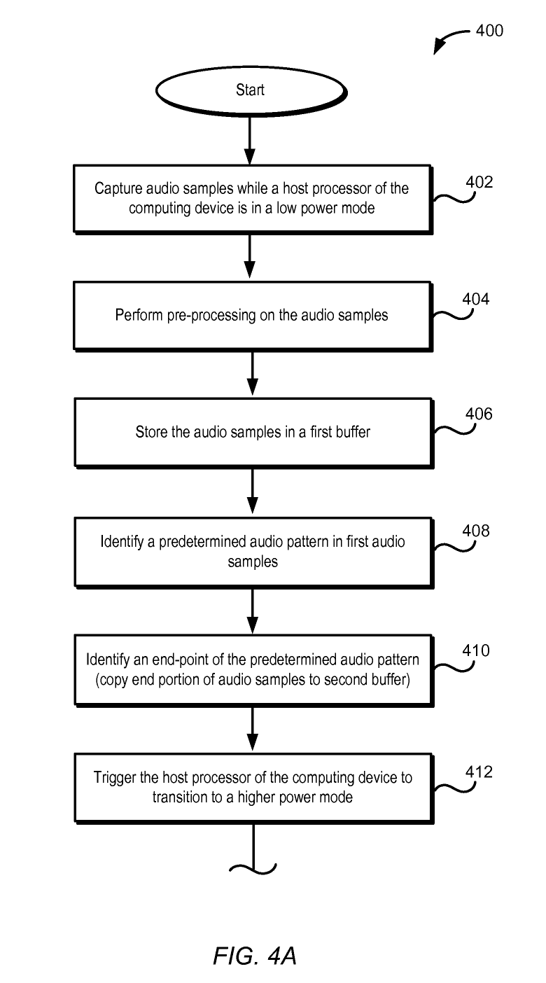

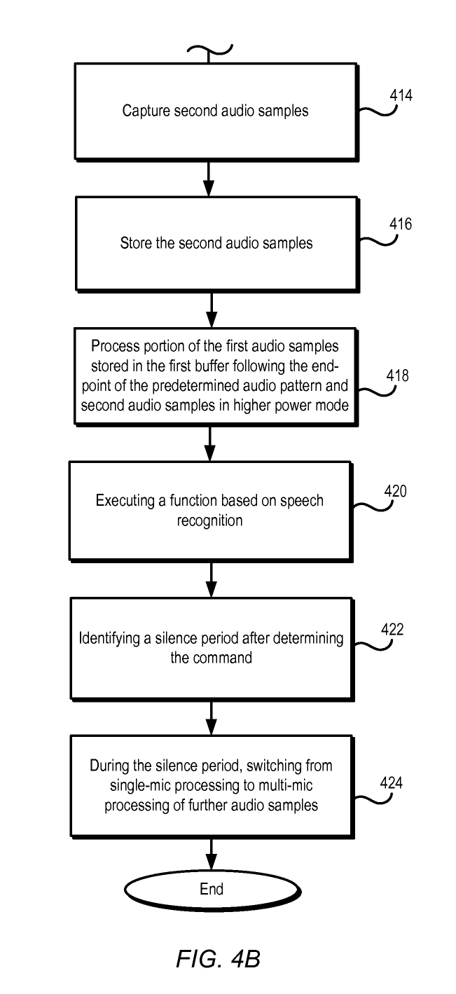

FIGS. 4A and 4B are a flow diagram of a method 400 of transitioning a computing device from a low power always listening mode to a high functionality mode, according to one embodiment. Audio samples are captured 402 from an audio signal received through a microphone while a host processor of the computing device is in a low functionality mode. Pre-processing 404 of first audio samples may occur. The pre-processing 404 may include one or more of acoustic echo cancellation, noise suppression, and other filtering that may clarify or otherwise improve the audio signal for speech recognition. The audio samples may be stored 406 in a buffer. Low power speech recognition on a low power audio processor may identify 408 a predetermined audio pattern in first audio samples. For example, the predetermined audio pattern may be an utterance “Hey Assistant.” The user may continue, seamlessly and without pause, to utter a speech interaction phrase, such as “what is the weather tomorrow?”, which may be partially included in the first audio samples. Accordingly, an end-point of the predetermined audio pattern may also be identified 410.

In response to identifying 408 the predetermined audio pattern, at least a portion of the first audio samples in the first buffer that follow the end-point of the predetermined audio pattern may be copied to system memory accessible by the host processor. For example, first audio samples in the first buffer that follow the end-point of the predetermined audio pattern may be copied to a second buffer. Also, in response to identifying 408 the predetermined audio pattern, the host processor of the computing device may be triggered 412 to transition to a high functionality mode. In addition, other elements of computing device may be triggered to a higher functionality mode. For example, one or more additional microphones of the computing device may be activated.

Second audio samples are captured 414. The second audio samples may be captured 414 from the audio signal received through the microphone. The second audio samples may also be captured 414 from one or more audio signals received through one or more additional microphones, which may have been activated. The second audio samples may be pre-processed. The pre-processing may include one or more of acoustic echo cancellation, beam-forming, noise suppression, and other filtering. For example, single channel noise suppression may be performed on the second audio samples. In another embodiment, multi-channel noise suppression may be performed on the second audio samples. The second audio samples are stored 416. The second audio samples may be stored 416 in a second buffer in, for example, system memory accessible by the host processor. In other embodiments, the second audio samples may be stored 416 in the first buffer, following the endpoint of the predetermined audio pattern.

Once the host processor transitions to the high functionality mode, the portion of the first audio samples stored in the first buffer following the end-point of the predetermined audio pattern and the second audio samples may be processed 418 by the host processor in the high functionality mode. For example, the portion of the first audio samples stored in the first buffer following the end-point of the predetermined audio pattern and the second audio samples may include the utterance “what is the weather tomorrow?” The host processor may perform large vocabulary speech recognition to enable a conversational user interface (CUI), such that the user may speak and the host processor may identify a speech interaction phrase, which may include queries and/or commands. The host processor may perform speech recognition to detect “what is the weather tomorrow?” and may execute 420 a function based this detected speech interaction phrase.

A silence period after a first speech interaction phrase may be identified 422. The silence period may occur following the first speech interaction phrase as the user awaits a response from the computing device. During the silence period, the computing device may switch 424 from single channel processing to multi-channel processing.

### EXAMPLE EMBODIMENTS

### Example 1

A computing system that transitions from a low functionality always listening mode to a higher functionality speech recognition mode, comprising: a host processor having a low functionality mode and a high functionality mode; a buffer to store audio samples; a low power audio processor to capture first audio samples from an audio signal received through a microphone while the host processor is in the low functionality mode and to store the first audio samples in the buffer, wherein the low power audio processor is configured to identify a predetermined audio pattern in the first audio samples, including an end-point of the predetermined audio pattern, and to trigger the host processor to transition to the high functionality mode, wherein the system is configured to, upon the low power audio processor triggering the host processor, capture second audio samples from audio signals received through one or more microphones and store the second audio samples, and wherein the host processor is configured to, in the high functionality mode, perform speech recognition processing on at least a portion of the first audio samples in the buffer that follow the end-point of the predetermined audio pattern and on the second audio samples.

### Example 2

The system of example 1, further comprising one or more onboard microphones each configured to receive an audio signal, wherein the one or more onboard microphones include the microphone and the one or more microphones.

### Example 3

The system of example 1, wherein the second audio samples are stored in the buffer following the end-point of the predetermined audio pattern.

### Example 4

The system of example 1, wherein the buffer comprises a first buffer to store audio samples captured while the host processor is in the low functionality mode, and wherein the system further comprises: a second buffer accessible to the host processor to store audio samples, wherein the second audio samples are stored in the second buffer, and wherein the system is configured to, upon the low power audio processor triggering the host processor, copy to the second buffer the at least a portion of the first audio samples that follow the end-point of the predetermined audio pattern.

### Example 5

The system of example 1, wherein the low power audio processor, comprises: a capture module to monitor the audio signal received by the onboard microphone while the host processor is in the low functionality mode and to capture audio samples of the audio signal; a language module to identify the predetermined audio pattern in the captured audio samples; and a trigger module to trigger the host processor of the computing device to transition to the high functionality mode based on the predetermined audio pattern.

### Example 6

The system of example 1, further comprising a single channel noise suppression module to perform noise suppression on the first audio samples.

### Example 7

The system of example 1, further comprising:

a multi-channel noise suppression module to perform noise suppression on the second audio samples.

### Example 8

The system of example 1, wherein the host processor is configured to, in the high functionality mode, perform speech recognition processing to identify a command.

### Example 9

The system of example 8, wherein the host processor is further configured to perform an additional function based on the identified command

### Example 10

The system of example 8, wherein the host processor is further configured to identify a silence period after determining the command and, during the silence period, switch the system from single-channel processing to multi-channel processing of second audio samples.

### Example 11

The system of example 1, further comprising a plurality of additional microphones operable to receive an audio signal when the host processor is in the high functionality mode, wherein the one or more microphones comprise the plurality of additional microphones, and wherein the second audio samples are captured from audio signals received through the plurality of additional microphones.

### Example 12

The system of example 1, wherein the low functionality mode comprises a low power mode.

### Example 13

The system of example 1, wherein the low functionality mode comprises a low power mode and a limited feature mode.

### Example 14

The system of example 1, wherein the low functionality mode comprises a limited feature mode.

### Example 15

The system of example 1, wherein the high functionality mode comprises a higher power mode.

### Example 16

The system of example 1, wherein the high functionality mode comprises a higher power mode and a higher feature mode.

### Example 17

The system of example 1, wherein the high functionality mode comprises a higher feature mode.

### Example 18

A method to transition a computing device from a low functionality mode to a high functionality mode, comprising: capturing first audio samples from an audio signal received through a microphone while a host processor of the computing device is in a low functionality mode; storing the first audio samples in a first buffer; identifying by a low power audio processor a predetermined audio pattern in the first audio samples, including an end-point of the predetermined audio pattern; in response to identifying the predetermined audio pattern, triggering the host processor of the computing device to transition to a high functionality mode; capturing second audio samples from the audio signal received through one or more microphones;

storing the second audio samples; and processing at least a portion of the first audio samples stored in the first buffer following the end-point of the predetermined audio pattern and the second audio samples by the host processor in the high functionality mode.

### Example 19

The method of example 18, further comprising copying to a second buffer the at least a portion of the first audio samples in the first buffer that follow the end-point of the predetermined audio pattern, wherein storing the second audio samples comprises storing the second audio samples in the second buffer.

### Example 20

The method of example 18, further comprising performing single channel noise suppression on the first audio samples captured while the host processor is in the low functionality mode.

### Example 21

The method of example 18, further comprising activating one or more microphones based on the predetermined audio pattern, wherein capturing second audio samples comprises capturing the second audio samples from audio signals received through the activated one or more microphones.

### Example 22

The method of example 21, further comprising performing multi-channel noise suppression on the second audio samples captured while the host processor is in the high functionality mode.

### Example 23

The method of example 18, wherein processing the at least a portion of the first audio samples and the second audio samples comprises performing speech recognition to determine a command.

### Example 24

The method of example 23, further comprising executing the command by the host processor in the high functionality mode.

### Example 25

The method of example 23, further comprising: identifying a silence period after determining the command; during the silence period, switching from single-mic processing to multi-mic processing of further audio samples.

### Example 26

The method of example 18, wherein the low functionality mode comprises a low power mode.

### Example 27

The method of example 18, wherein the low functionality mode comprises a low power mode and a limited feature mode.

### Example 28

The method of example 18, wherein the low functionality mode comprises a limited feature mode.

### Example 29

The method of example 18, wherein the high functionality mode comprises a higher power mode.

### Example 30

The method of example 18, wherein the high functionality mode comprises a higher power mode and a higher feature mode.

### Example 31

The method of example 18, wherein the high functionality mode comprises a higher feature mode.

### Example 32

A computing system that transitions from a low functionality always listening mode to a higher functionality speech recognition mode, the system configured to perform the method of any of examples 18-31.

### Example 33

A low power always listening digital signal processor, comprising: a capture module to monitor an audio signal received by a microphone while a host processor is in a low functionality mode and to capture first audio samples of the audio signal; a language module to identify a predetermined audio pattern in the first audio samples, including an end-point of the predetermined audio pattern; and a trigger module to, in response to the language module identifying the predetermined audio pattern, trigger the host processor to transition to a high functionality mode and initiate speech recognition processing on a portion of the first audio samples captured after the end-point of the predetermined audio pattern and on second audio samples captured after the trigger module triggers the host processor.

### Example 34

The low power always listening digital signal processor of example 33, further comprising a first buffer to store the first audio samples.

### Example 35

The low power always listening digital signal processor of example 34, wherein the first buffer is accessible by the host processor.

### Example 36

The low power always listening digital signal processor of example 33, further comprising an onboard microphone to receive the audio signal while the host processor is in the low functionality mode.

### Example 37

The low power always listening digital signal processor of example 33, further comprising a flush module to copy to a second buffer a portion of the first audio samples captured after the end-point of the predetermined audio pattern, the second buffer being accessible by the host processor.

### Example 38

One or more machine-readable storage media comprising a plurality of instructions stored thereon that in response to being executed result in a computing device performing the method of any of claims 18-31.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be obvious to those having skill in the art that many changes may be made to the details of the above-described embodiments without departing from the underlying principles of the invention. The scope of the present invention should, therefore, be determined only by the following claims.

We claim:

1-26. (canceled)

27. A computing system that transitions from a low functionality always listening mode to a higher functionality speech recognition mode, comprising:
a host processor having a low functionality mode and a high functionality mode;
a buffer to store audio samples;
a low power audio processor to capture first audio samples from an audio signal received through a microphone while the host processor is in the low functionality mode and to store the first audio samples in the buffer, wherein the low power audio processor is configured to identify a predetermined audio pattern in the first audio samples, including an end-point of the predetermined audio pattern, and to trigger the host processor to transition to the high functionality mode,
wherein the system is configured to, upon the low power audio processor triggering the host processor, capture second audio samples from audio signals received through one or more microphones and store the second audio samples, and
wherein the host processor is configured to, in the high functionality mode, perform speech recognition processing on at least a portion of the first audio samples in the buffer that follow the end-point of the predetermined audio pattern and on the second audio samples.

28. The system of claim 27, further comprising one or more onboard microphones each configured to receive an audio signal, wherein the one or more onboard microphones include the microphone and the one or more microphones.

29. The system of claim 27, wherein the second audio samples are stored in the buffer following the end-point of the predetermined audio pattern.

30. The system of claim 27, wherein the buffer comprises a first buffer to store audio samples captured while the host processor is in the low functionality mode, and wherein the system further comprises:
a second buffer accessible to the host processor to store audio samples,
wherein the second audio samples are stored in the second buffer, and
wherein the system is configured to, upon the low power audio processor triggering the host processor, copy to the second buffer the at least a portion of the first audio samples that follow the end-point of the predetermined audio pattern.

31. The system of claim 27, wherein the low power audio processor, comprises:
a capture module to monitor the audio signal received by the onboard microphone while the host processor is in the low functionality mode and to capture audio samples of the audio signal;
a language module to identify the predetermined audio pattern in the captured audio samples; and
a trigger module to trigger the host processor of the computing device to transition to the high functionality mode based on the predetermined audio pattern.

32. The system of claim 27, further comprising a single channel noise suppression module to perform noise suppression on the first audio samples.

33. The system of claim 27, further comprising a multi-channel noise suppression module to perform noise suppression on the second audio samples.

34. The system of claim 27, wherein the host processor is configured to, in the high functionality mode, perform speech recognition processing to identify a command.

35. The system of claim 34, wherein the host processor is further configured to perform an additional function based on the identified command

36. The system of claim 34, wherein the host processor is further configured to identify a silence period after determining the command and, during the silence period, switch the system from single-channel processing to multi-channel processing of second audio samples.

37. The system of claim 27, further comprising a plurality of additional microphones operable to receive an audio signal when the host processor is in the high functionality mode,
wherein the one or more microphones comprise the plurality of additional microphones, and
wherein the second audio samples are captured from audio signals received through the plurality of additional microphones.

38. A method to transition a computing device from a low functionality mode to a high functionality mode, comprising:
capturing first audio samples from an audio signal received through a microphone while a host processor of the computing device is in a low functionality mode;
storing the first audio samples in a first buffer;
identifying by a low power audio processor a predetermined audio pattern in the first audio samples, including an end-point of the predetermined audio pattern;
in response to identifying the predetermined audio pattern, triggering the host processor of the computing device to transition to a high functionality mode;
capturing second audio samples from the audio signal received through one or more microphones;
storing the second audio samples; and
processing at least a portion of the first audio samples stored in the first buffer following the end-point of the predetermined audio pattern and the second audio samples by the host processor in the high functionality mode.

39. The method of claim 38, further comprising copying to a second buffer the at least a portion of the first audio samples in the first buffer that follow the end-point of the predetermined audio pattern,
wherein storing the second audio samples comprises storing the second audio samples in the second buffer.

40. The method of claim 38, further comprising performing single channel noise suppression on the first audio samples captured while the host processor is in the low functionality mode.

41. The method of claim 38, further comprising activating one or more microphones based on the predetermined audio pattern, wherein capturing second audio samples comprises capturing the second audio samples from audio signals received through the activated one or more microphones.

42. The method of claim 41, further comprising performing multi-channel noise suppression on the second audio samples captured while the host processor is in the high functionality mode.

43. The method of claim 38, wherein processing the at least a portion of the first audio samples and the second audio samples comprises performing speech recognition to determine a command.

44. The method of claim 43, further comprising executing the command by the host processor in the high functionality mode.

45. The method of claim 43, further comprising:
identifying a silence period after determining the command;
during the silence period, switching from single-mic processing to multi-mic processing of further audio samples.

46. A low power always listening digital signal processor, comprising:
a capture module to monitor an audio signal received by a microphone while a host processor is in a low functionality mode and to capture first audio samples of the audio signal;
a language module to identify a predetermined audio pattern in the first audio samples, including an end-point of the predetermined audio pattern; and
a trigger module to, in response to the language module identifying the predetermined audio pattern, trigger the host processor to transition to a high functionality mode and initiate speech recognition processing on a portion of the first audio samples captured after the end-point of the predetermined audio pattern and on second audio samples captured after the trigger module triggers the host processor.

47. The low power always listening digital signal processor of claim 46, further comprising a first buffer to store the first audio samples.

48. The low power always listening digital signal processor of claim 47, wherein the first buffer is accessible by the host processor.

49. The low power always listening digital signal processor of claim 46, further comprising an onboard microphone to receive the audio signal while the host processor is in the low functionality mode.

50. The low power always listening digital signal processor of claim 46, further comprising a flush module to copy to a second buffer a portion of the first audio samples captured after the end-point of the predetermined audio pattern, the second buffer being accessible by the host processor.

51. One or more machine-readable storage media having stored thereon a plurality of instructions that, in response to being executed by a computing device, result in the computing device performing operations comprising:
capturing first audio samples from an audio signal received through a microphone while a host processor of the computing device is in a low functionality mode;
storing the first audio samples in a first buffer;
identifying by a low power audio processor a predetermined audio pattern in the first audio samples, including an end-point of the predetermined audio pattern;
in response to identifying the predetermined audio pattern, triggering the host processor of the computing device to transition to a high functionality mode;
capturing second audio samples from the audio signal received through one or more microphones;
storing the second audio samples; and
processing at least a portion of the first audio samples stored in the first buffer following the end-point of the predetermined audio pattern and the second audio samples by the host processor in the high functionality mode.

52. The one or more machine-readable storage media of claim 51, further comprising instructions that, in response to being executed by the computing device, result in the computing device performing operations comprising:
copying to a second buffer the at least a portion of the first audio samples in the first buffer that follow the end-point of the predetermined audio pattern,
wherein storing the second audio samples comprises storing the second audio samples in the second buffer.

53. The one or more machine-readable storage media of claim 51, further comprising instructions that, in response to being executed by the computing device, result in the computing device performing operations comprising:
activating one or more microphones based on the predetermined audio pattern, wherein capturing second audio samples comprises capturing the second audio samples from audio signals received through the activated one or more microphones.

54. The one or more machine-readable storage media of claim 51, wherein processing the at least a portion of the first audio samples and the second audio samples comprises performing speech recognition to determine a command.
